(19) United States
(12) Patent Application Publication
(10) Pub. No.: US 2026/0089491 A1
(43) Pub. Date: Mar. 26, 2026

(54) ELECTRONIC APPARATUS AND CONTROLLING METHOD THEREOF

(71) Applicant: Samsung Electronics Co., Ltd., Suwon-si (KR)

(72) Inventor: Hanbi PARK, Suwon-si (KR)

(21) Appl. No.: 19/312,785

(22) Filed: Aug. 28, 2025

Related U.S. Application Data
(63) Continuation of application No. PCT/KR2025/012127, filed on Aug. 11, 2025.

(30) Foreign Application Priority Data
Sep. 24, 2024 (KR) 10-2024-0129282

(51) Int. Cl. H04W 8/24; G06F 11/34; H04W 76/14

(52) U.S. Cl. CPC H04W 8/24; G06F 11/3476; H04W 76/14

(57) ABSTRACT

An electronic apparatus is provided. An electronic apparatus includes a communication interface for performing communication with a server, memory, comprising one or more storage media, storing instructions and first identification information of the electronic apparatus, which is generated based on hardware information of the electronic apparatus and at least one processor communicatively coupled to the communication interface and the memory and capable of executing the instructions, wherein the instructions, when executed by the at least one processor individually or collectively, cause the electronic apparatus to, based on the hardware information being changed, obtain second identification information of the electronic apparatus, identify a log that the first identification information has been transmitted to the server, and based on identifying the log, transmit the second identification information to the server to update identification information of the electronic apparatus in the server to the second identification information.

### CROSS-REFERENCE TO RELATED APPLICATIONS

This application is a continuation application, claiming priority under 35 U.S.C. § 365(c), of an International application No. PCT/KR2025/012127, filed on August 11, 2025, which is based on and claims the benefit of a Korean patent application number 10-2024-0129282, filed on September 24, 2024, in the Korean Intellectual Property Office, the disclosure of which is incorporated by reference herein in its entirety.

### BACKGROUND

### Field

The disclosure relates to an electronic apparatus and a controlling method thereof. More particularly, the disclosure relates to an electronic apparatus for updating the identification information of the electronic apparatus when hardware information of the electronic apparatus is changed and a controlling method thereof.

### Description of Related Art

With the development of electronic technology, various types of electronic apparatuses are being used in our daily lives. Among these electronic apparatuses, there may be electronic apparatuses that update and manage the identification information of the electronic apparatuses when hardware information of the electronic apparatuses is changed.

When the hardware information of an electronic apparatuses is changed, the identification information of the electronic apparatus may also be changed. In this case, there may be a case where the existing identification information and the changed identification information do not match.

The identification information of an electronic apparatus may be information for uniquely identifying the electronic apparatus. Specifically, the identification information may include hardware information.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus for updating the identification information of the electronic apparatus when hardware information of the electronic apparatus is changed and a controlling method thereof.

Additional aspects will be set forth in part in the description which follows and, in part, will be apparent from the description, or may be learned by practice of the presented embodiments.

In accordance with an aspect of the disclosure, an electronic apparatus is provided. An electronic apparatus includes a communication interface for performing communication with a server, memory, comprising one or more storage media, storing instructions and first identification information of the electronic apparatus, which is generated based on hardware information of the electronic apparatus and at least one processor communicatively coupled to the communication interface and the memory and capable of executing the instructions, wherein the instructions, when executed by the at least one processor individually or collectively, cause the electronic apparatus to, based on the hardware information being changed, obtain second identification information of the electronic apparatus, identify a log that the first identification information has been transmitted to the server, and based on identifying the log, transmit the second identification information to the server to update identification information of the electronic apparatus in the server to the second identification information.

In accordance with another aspect of the disclosure, a method of controlling an electronic apparatus that manages identification information of the electronic apparatus is provided. The method includes, based on hardware information of the electronic apparatus being changed, obtaining second identification information of the electronic apparatus, identifying a log that first identification information of the electronic apparatus has been transmitted to a server and based on identifying the log, transmitting the second identification information to the server to update identification information of the electronic apparatus in the server to the second identification information.

In accordance with another aspect of the disclosure, one or more non-transitory computer-readable storage media storing one or more computer programs including computer-executable instructions that, when executed by one or more processors of an electronic apparatus individually or collectively causes the electronic apparatus to perform operations are provided. The operations include based on hardware information of the electronic apparatus being changed, obtaining second identification information of the electronic apparatus, identifying a log that first identification information of the electronic apparatus has been transmitted to a server and based on identifying the log, transmitting the second identification information to the server to update identification information of the electronic apparatus in the server to the second identification information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view provided to explain an operation of an electronic apparatus according to an embodiment of the disclosure;

FIG. 2 is a block diagram illustrating configuration of an electronic apparatus according to an embodiment of the disclosure;

FIG. 3 is a detailed block diagram provided to explain an electronic apparatus according to an embodiment of the disclosure;

FIG. 4 is a flowchart provided to explain an operation of managing identification information by an electronic apparatus according to an embodiment of the disclosure;

FIG. 5 is a flowchart provided to explain an operation of managing identification information by an electronic apparatus according to an embodiment of the disclosure;

FIG. 6 is a flowchart provided to explain an operation of managing identification information by an electronic apparatus according to an embodiment of the disclosure;

FIG. 7 is a flowchart provided to explain an operation of updating identification information by a server according to an embodiment of the disclosure;

FIG. 8 is a flowchart provided to explain a method of managing identification information by an electronic apparatus according to an embodiment of the disclosure;

FIG. 9 is a flowchart provided to explain a method of managing identification information by an electronic apparatus according to an embodiment of the disclosure;

FIG. 10 is a sequence view illustrating an order in which an electronic apparatus and a server operate according to an embodiment of the disclosure; and

FIG. 11 is a sequence view illustrating an order in which an electronic apparatus, an access point (AP) and a sever operate according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Various embodiments in this disclosure and the terms used herein do not intend to limit the technical features in this disclosure to specific embodiments, but should be understood to include various modifications, equivalents, or alternatives of the corresponding embodiments.

With respect to the description of the drawings, similar components may be denoted by similar reference numerals.

In this disclosure, “A or B,” “at least one of A and B,” “at least one of A or B,” “A, B or C,” “at least one of A, B and C,” and “at least one of A, B, or C” may each include any one of the items listed together in the corresponding phrase, or any possible combination thereof.

Terms “first,” “second,” “1^{st},” or “2^{nd},” may be used simply to distinguish the corresponding component from other corresponding components, and may limit the corresponding components in other aspects (e.g., importance or order).

When it is mentioned that one (e.g., first) component is “coupled” or “connected” to another (e.g., second) component, with or without the terms “functionally” or “communicatively,” it means that the component can be connected to another component directly (e.g. wired), wirelessly, or through a third component.

Terms such as “have” or “include” are intended to designate the presence of features, numbers, steps, operations, components, parts, or a combination thereof described in this disclosure, but are not intended to exclude the presence or addition of one or more other features, numbers, steps, operations, components, parts, or a combination thereof in advance.

When a component is said to be “connected,” “coupled,” “supported,” or “in contact” with another component, this means not only when the components are directly connected, coupled, supported, or in contact, but also when they are indirectly connected, coupled, supported, or in contact through a third component.

When a component is said to be located “on” another component, this includes not only a case where a component is in contact with another component, but also a case where another component exists between the two components.

The term “and/or” includes a combination of a plurality of related components described herein or any component of a plurality of related components described herein.

In embodiments, a “module” or “part” performs at least one function or operation and may be implemented in hardware or software, or a combination of hardware and software. Further, a plurality of “modules” or a plurality of “parts” may be integrated into at least one module and implemented on at least one processor, except for those “modules” or “parts” that need to be implemented on specific hardware.

Meanwhile, the various components and areas in the drawings are schematically depicted. Accordingly, the technical ideas of the disclosure are not limited by the relative sizes or spacing depicted in the accompanying drawings.

In the disclosure, the term ‘user’ may refer to a person using an electronic apparatus or a device using an electronic apparatus (e.g., an artificial intelligence electronic apparatus).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, an embodiment of the disclosure will be described in greater detail with reference to the accompanying drawings.

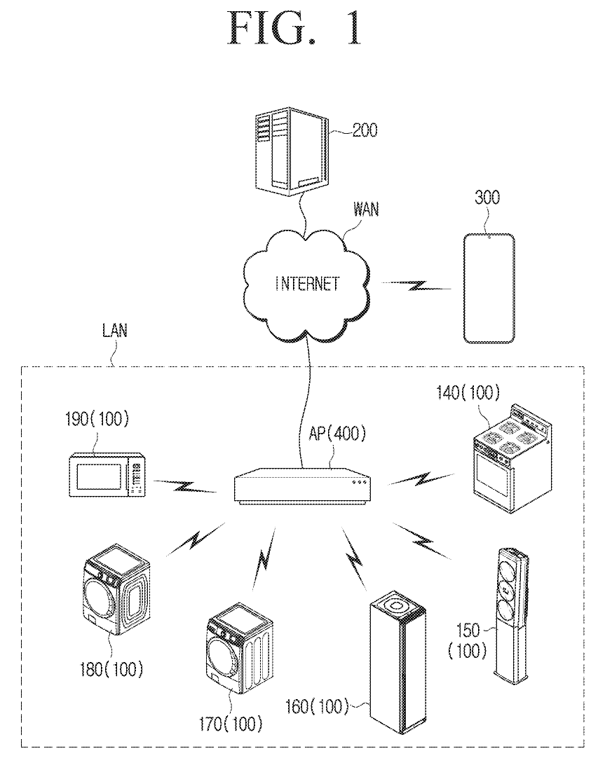

FIG. 1 is a view provided to explain an operation of an electronic apparatus according to an embodiment of the disclosure.

The electronic apparatus 100 may include a communication interface capable of performing communication with another electronic apparatus, a user terminal device 300 or a server 200, at least one processor configured to control the operation of the electronic apparatus 100, and memory storing a program for controlling the operation of the electronic apparatus 100.

The electronic apparatus 100 may be at least one of various types of electronic apparatuses. For example, the electronic apparatus 100 may include at least one of an electric oven 140, an air conditioner 150, a clothes manager 160, a washing machine 170, a dryer 180, and a microwave oven 190 as illustrated the drawing, but is not limited thereto, and may include various types of home appliances, for example, a cleaning robot, a vacuum cleaner, a television, etc. which are not illustrated in the drawing.

In addition, the aforementioned home appliances are merely examples, and in addition to the aforementioned electronic apparatuses, devices that are connected to other electronic apparatuses, a user terminal device 300, or a server 200 and can perform the operations described below may be included in the electronic apparatus 100 according to an embodiment.

The server 200 may include a communication module capable of performing communication with other servers, the electronic apparatus 100, or the user terminal device 300, at least one processor capable of processing data received from other servers, the electronic apparatus 100, or the user terminal device 300, and at least one memory capable of storing a program for processing data or processed data. The server 200 may be implemented as various computing devices such as a workstation, a cloud, a data drive, or a data station.

The server 200 may be implemented as one or more servers that are physically or logically separated based on function, detailed configuration of the function, or data, and may perform communication with each other to send/receive data and process the sent/received data.

The server 200 may perform functions such as managing user accounts, registering the electronic apparatus 100 by linking them to user accounts, and managing or controlling registered the electronic apparatus 100. For example, a user may access the server 200 through the user terminal device 300 and create a user account. The user account may be identified by an identifier (ID) and password set by the user.

The server 200 may register the electronic apparatus 100 to a user account according to a set procedure. For example, the server 200 may register, manage, and control the electronic apparatus 100 by linking the identification information (e.g., serial number or medium access control (MAC) address) of the electronic apparatus 100 to the user account.

The server 200 may be, for example, a server that manages identification information for a user's electronic apparatus. The server 200 may be a file transfer protocol (FTP) server, a web server, a database server, or a cloud-type server, and the server may be built with an operating system such as Linux.

The server 200 may be a server linked to a user account. The server 200 may store user account information, and identification information and control information for the electronic apparatus 100 connected to the server 200. The server 200 may perform a communication connection with an access point (AP) 400 to transmit or receive user account information, and identification information and control information for the electronic apparatus 100 connected to the AP 400.

The user terminal device 300 may include a communication module capable of performing communication with the electronic apparatus 100 or the server 200, a user interface that receives a user input or outputs information to the user, at least one processor that controls the operation of the user terminal device 300, and at least one memory storing a program for controlling the operation of the user terminal device 300.

The user terminal device 300 may be carried by the user or placed in the user's home or office, etc. The user terminal device 300 may include, but is not limited to, a personal computer, a terminal, a portable telephone, a smart phone, a handheld device, a wearable device, etc.

A program for controlling the electronic apparatus 100, i.e., an application, may be stored in the memory of the user terminal device 300. The application may be sold installed in the user terminal device 300 or downloaded and installed from an external server.

By executing an application installed in the user terminal device 300, the user may access the server 200 to create a user account, and may register the electronic apparatus 100 by performing communication with the server 200 based on the logged-in user account.

For example, when the electronic apparatus 100 is operated so that the electronic apparatus 100 can be connected to the server 200 according to the procedure guided by the application installed on the user terminal device 300, the electronic apparatus 100 may be registered in the user account by registering identification information (e.g., serial number or MAC address, etc.) of the electronic apparatus 100 in the corresponding user account on the server 200.

The user may control the electronic apparatus 100 using an application installed on the user terminal device 300. For example, when the user logs into the user account using an application installed on a user terminal device 300, the electronic apparatus 100 registered in the user account appears, and when a control command for the electronic apparatus 100 is input, the control command can be transmitted to the electronic apparatus 100 via the server 200.

The AP 400 may be a hub device that relays wireless internet access. The AP 400 may be a router, a wired/wireless router, or a Wi-Fi router, but is not limited thereto.

The AP 400 may perform a communication connection with the server 200 to transmit or receive user account information, and identification information and control information of the electronic apparatus 100 connected to the AP 400.

The AP 400 may perform a communication connection with the electronic apparatus 100, the server 200 or the user terminal device 300 to transmit or receive user account information, and identification information and control information for the electronic apparatus 100 connected to the AP 400.

Here, the identification information of the electronic apparatus may be information for uniquely identifying the electronic apparatus. Specifically, the identification information may include hardware information. Such identification information may be changed according to changes in the hardware information of the electronic apparatus, and may also be expressed as a device ID.

Here, the hardware information of the electronic apparatus may be unique information of the hardware that constitutes the electronic apparatus.

The electronic apparatus 100 may perform a communication connection with the AP 400 through a communication interface to transmit or receive connection information, user account information, device identification information, and device control information for the access point.

For example, when hardware information is changed, the electronic apparatus 100 may obtain changed identification information based on the changed hardware information, perform a communication connection with the AP 400 to update the changed identification information, and transmit it to the server 200.

However, the disclosure is not limited thereto, and the electronic apparatus 100 may be directly connected to the user terminal device 300 or the server 200 without going through the AP 400.

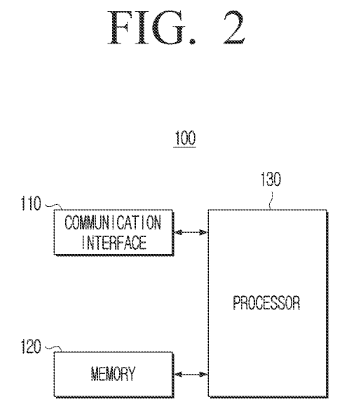

FIG. 2 is a block diagram illustrating configuration of an electronic apparatus according to an embodiment of the disclosure.

Referring to FIG. 2, the electronic apparatus 100 includes a communication interface 110, memory 120, and at least one processor 130.

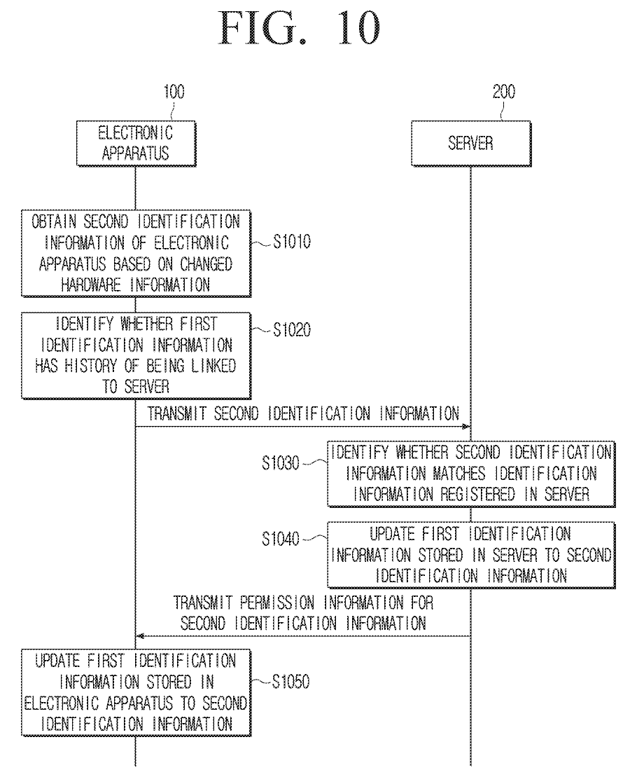

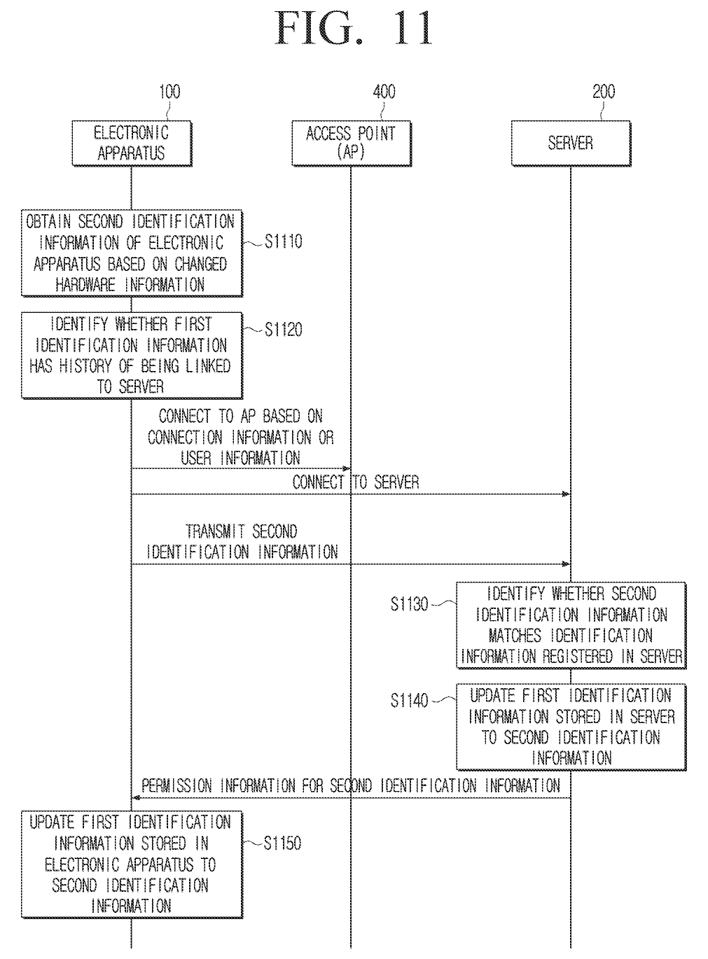

According to an embodiment, the communication interface 110 may perform communication with the server 200 or the AP 400. In particular, the communication interface 110 may transmit first identification information of the electronic apparatus 100 generated based on hardware information of the electronic apparatus 100 or second identification information of the electronic apparatus 100 obtained based on changed hardware information to the server 200 in order to update identification information of the electronic apparatus 100 linked to the server 200. The operation of performing communication with an external device will be described in detail with reference to FIGS. 10 and 11.

The communication interface 110 may include wired or wireless input/output interface (or input/output terminal) according to various standards. For example, the communication interface 110 may include various interfaces such as high definition multimedia interface (HDMI), mobile high-definition link (MHL), universal serial bus (USB), display port (DP), Thunderbolt, video graphics array (VGA) port, RGB port, D-subminiature (D-SUB), digital visual interface (DVI), AP-based Wi-Fi (wireless LAN network), Bluetooth, Zigbee, wired/wireless local area network (LAN), wide area network (WAN), ethernet, IEEE 1394, Audio Engineering Society/European Broadcasting Union (AES/EBU), optical, coaxial, etc.

According to an embodiment, the memory 120 may store data required for various embodiments of the disclosure. The memory 120 may be implemented as memory embedded in the electronic apparatus 100 or as memory detachable from the electronic apparatus 100 depending on the data storage purpose.

For example, in the case of data for driving the electronic apparatus 100, the data may be stored in the memory embedded in the electronic apparatus 100, and in the case of data for the expansion function of the electronic apparatus 100, the data may be stored in the memory detachable from the electronic apparatus 100.

The memory embedded in the electronic apparatus 100 may be implemented in the form of a volatile memory (e.g. dynamic random access memory (DRAM), a static RAM (SRAM), or a synchronous dynamic RAM (SDRAM)), or a non-volatile memory (e.g., one-time programmable read only memory (OTPROM), a programmable ROM (PROM), an erasable and programmable ROM (EPROM), an electrically erasable and programmable ROM (EEPROM), a mask ROM, a flash ROM, flash memory (e.g. a NAND flash or a NOR flash), a hard drive, or a solid state drive (SSD)).

The memory detachable from the electronic apparatus 100 may be implemented in the form of a memory card (e.g., a compact flash (CF), a secure digital (SD), a micro secure digital (Micro-SD), a mini secure digital (Mini-SD), an extreme digital (xD), or a multi-media card (MMC)), external memory connectable to a USB port (e.g., a USB memory), or the like.

The memory 120 may include various instructions necessary for the operation of at least one processor 130. Here, the instructions may include an instruction for obtaining second identification information of the electronic apparatus 100 based on changed hardware information, an instruction for identifying whether the first identification information has a history of being linked to the server 200, an instruction for transmitting the second identification information to the server 200 so that the linked first identification information is updated to the second identification information, an instruction for performing a communication connection with the server 200 based on the linked first identification information, etc.

The memory 120 may store identification information of the electronic apparatus 100. Here, the identification information may be first identification information of the electronic apparatus 100 generated based on hardware information of the electronic apparatus 100 or second identification information of the electronic apparatus 100 obtained based on changed hardware information.

For example, the electronic apparatus 100 may obtain identification information based on information such as hardware configuration information, hardware version information, and serial information of the electronic apparatus 100. However, the disclosure is not limited thereto, and the identification information may be information received from an external device or stored in the memory 120 in advance.

According to an embodiment, at least one processor 130 controls the overall operations of the electronic apparatus 100. Specifically, at least one processor 130 may be connected to each component of the electronic apparatus 100 to control the overall operations of the electronic apparatus 100.

According to an embodiment, at least one processor 130 may control the server 200, the user terminal device 300, or the AP 400.

The at least one processor 130 may perform the operations of the electronic apparatus 100 according to various embodiments by executing at least one instruction stored in the memory 120.

When the hardware information of the electronic apparatus 100 is changed, the at least one processor 130 may obtain second identification information of the electronic apparatus 100 based on the changed hardware information.

For example, when a communication module included in the electronic apparatus 100 is replaced, the electronic apparatus 100 may obtain identification information of the changed electronic apparatus 100 based on unique information of the replaced communication module.

When obtaining the changed second identification information, the at least one processor 130 may identify whether the first identification information stored in the memory 120 has a history of being linked to the server 200.

When it is identified that the first identification information has a history of being linked to the server 200, the at least one processor 130 may transmit second identification information to the server 200 so that the linked first identification information is updated to the second identification information.

For example, when a device is registered in the server 200 based on the first identification information of the electronic apparatus 100, the at least one processor 130 may transmit the second identification information to the server 200 so that the registered first identification information is updated to the changed second identification information.

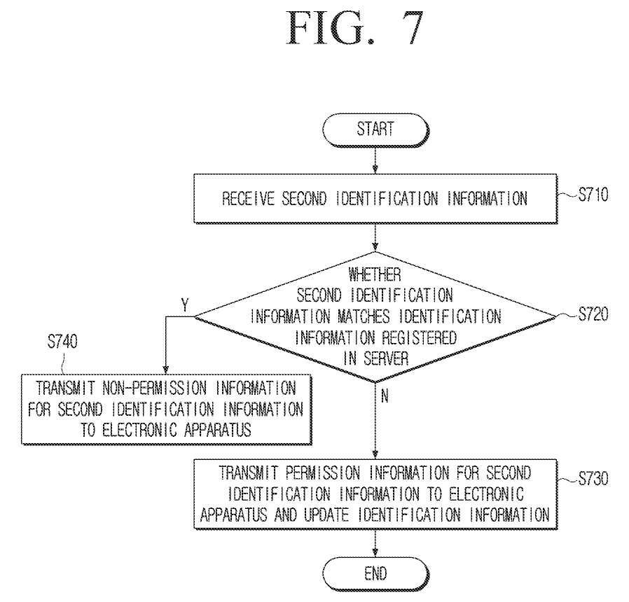

However, when there is identification information that matches the second identification information among identification information registered in the server 200, the server 200 may not update the first identification information of the electronic apparatus 100 to the second identification information in order to prevent duplicate registration. The specific operation thereof will be described in detail with reference to FIG. 7.

When it is identified that the first identification information has a history of being linked to the server 200, the at least one processor 130 may perform a communication connection with the server 200 based on the linked first identification information. In this case, the at least one processor 130 may perform a communication connection with the server 200 through the AP 400, and may also perform a communication connection with the server 200 directly without going through the AP 400.

According to an embodiment, the at least one processor 130 may be implemented as a digital signal processor (DSP) for processing a digital signal, a microprocessor, or a timing controller (TCON). However, the at least one processor 130 is not limited thereto, and may include one or more of a central processing unit (CPU), a micro controller unit (MCU), a micro processing unit (MPU), a controller, an application processor (AP), a communication processor (CP), an ARM processor, or an artificial intelligence (AI) processor, or may be defined by the corresponding terms. In addition, the at least one processor 130 may be implemented as a system on chip (SoC) or a large scale integration (LSI) with a built-in processing algorithm, or may be implemented in the form of a field programmable gate array (FPGA). The at least one processor 130 may perform various functions by executing computer executable instructions stored in the memory.

The at least one processor 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator.

The at least one processor 130 may control one or any combination of the other components of the electronic apparatus 100, and may perform communication-related operations or data processing. The at least one processor 130 may execute one or more programs or instructions stored in the memory 120. For example, the at least one processor 130 may perform a method according to an embodiment by executing one or more instructions stored in the memory.

When a method according to an embodiment of the disclosure includes a plurality of operations, the plurality of operations may be performed by one processor or may be performed by multiple processors.

For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The at least one processor 130 may be implemented as a single core processor including one core, or may be implemented as one or more multicore processors including multiple cores (e.g., homogeneous multi-core or heterogeneous multi-core).

When at least one processor 130 is implemented as a multi-core processor, each of the plurality of cores included in the multi-core processor may include internal processor memory, such as cache memory and on-chip memory, and a common cache shared by the plurality of cores may be included in the multi-core processor.

Each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment.

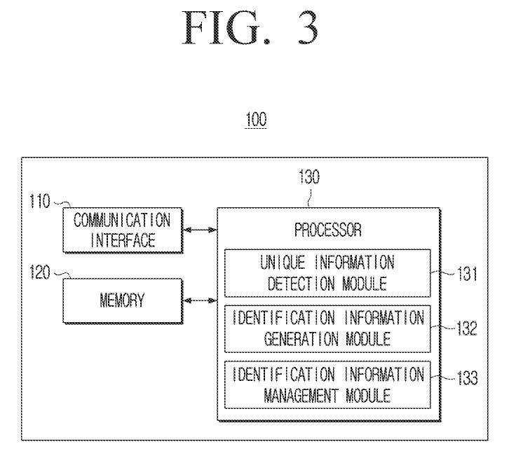

FIG. 3 is a detailed block diagram illustrating an electronic apparatus according to an embodiment of the disclosure.

Referring to FIG. 3, the electronic apparatus 100 according to an embodiment may include the communication interface 110, the memory 120, and the at least one processor 130. Parts that overlap with the above description will be omitted or abbreviated.

The at least one processor 130 may include a unique information detection module 131, an identification information generation module 132, and an identification information management module 133.

The at least one processor 130 may detect and obtain unique information of the hardware through the unique information detection module 131.

In addition, the at least one processor 130 may generate identification information of the electronic apparatus 100 based on the unique information of the hardware through the identification information generation module 132 and store it in the memory 120.

Further, at least one processor 130 may perform a communication connection with the server 200 using the identification information of the electronic apparatus 100 through the identification information management module 133, and transmit or update the identification information of the electronic apparatus 100 to the server 200.

Specifically, when the first identification information linked to the server 200 is updated to the second identification information, the at least one processor 130 may update the first identification information stored in the memory 120 of the electronic apparatus 100 to the second identification information and perform a communication connection with the server 200 based on the second identification information.

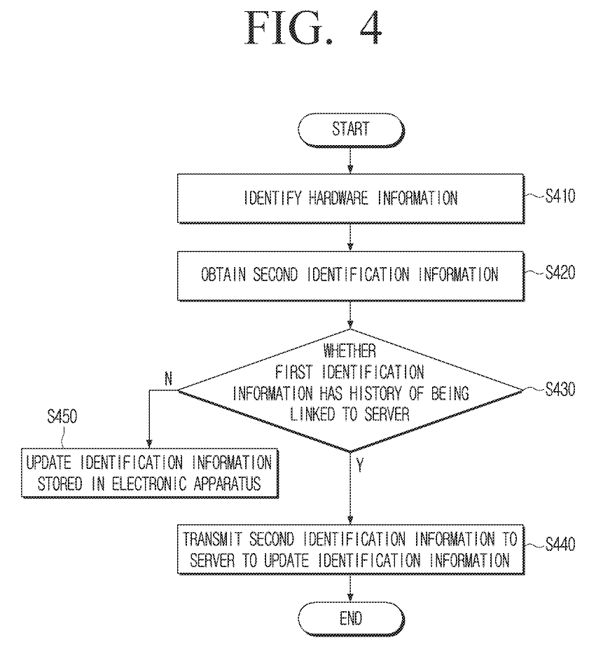

Hereinafter, the overall control operations of the electronic apparatus 100 of the at least one processor 130 will be described in detail with reference to FIGS. 4 to 7.

FIG. 4 is a flowchart provided to explain an operation of managing identification information by an electronic apparatus according to an embodiment of the disclosure.

The at least one processor 130 may identify that hardware information of the electronic apparatus 100 has been changed through the unique information detection module 131 at operation S410.

The at least one processor 130 may obtain the second identification information of the electronic apparatus 100 based on the changed hardware information at operation S420.

The at least one processor 130 may identify whether the first identification information has a history of being linked to the server 200 at operation S430.

When it is identified that the first identification information has a history of being linked to the server 200, the at least one processor 130 may transmit the second identification information to the server 200 so that the linked first identification information is updated to the second identification information at operation S440.

When it is identified that the first identification information has no history of being linked to the server 200, the at least one processor 130 may update the first identification information stored in the memory 120 to the second identification information at operation S450.

For example, when it is identified that the first identification information has no history of being linked to the server 200, the at least one processor 130 may delete the first identification number stored in the memory 120 and store the second identification information obtained based on the changed hardware information as new identification information.

In this case, the at least one processor 130 may perform a communication connection with the server 200 based on the updated second identification information without performing a communication connection with the server 200 based on the first identification information.

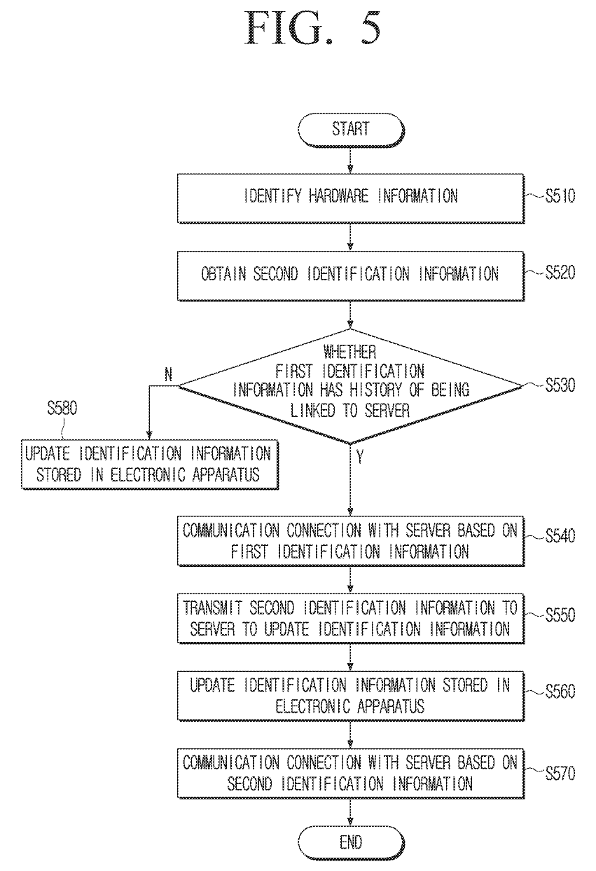

FIG. 5 is a flowchart provided to explain an operation of managing identification information by an electronic apparatus according to an embodiment of the disclosure.

The at least one processor 130 may identify that hardware information of the electronic apparatus 100 has been changed through the unique information detection module 131 at operation S510.

The at least one processor 130 may obtain second identification information of the electronic apparatus 100 based on the changed hardware information at operation S520.

The at least one processor 130 may identify whether the first identification information has a history of being linked to the server 200 at operation S530.

When it is identified that the first identification information has a history of being linked to the server 200, the at least one processor 130 may perform a communication connection with the server 200 based on the linked first identification at operation S540. In other words, the at least one processor 130 may perform a communication connection with the server 200 based on the previously linked identification information, not the changed identification information.

When it is identified that the first identification information has a history of being linked to the server 200, the at least one processor 130 may transmit the second identification information to the server 200 so that the linked first identification information is updated to the second identification information at operation S550.

When the first identification information linked to the server 200 is updated to the second identification information, the at least one processor 130 may update the first identification information stored in the memory 120 to the second identification information at operation S560.

The at least one processor 130 may perform a communication connection with the server 200 based on the second identification information at operation S570.

Meanwhile, when it is identified that the first identification information has no history of being linked to the server 200, the at least one processor 130 may update the first identification information stored in the memory 120 to the second identification information without performing a communication connection with the server 200 based on the first identification information at operation S580.

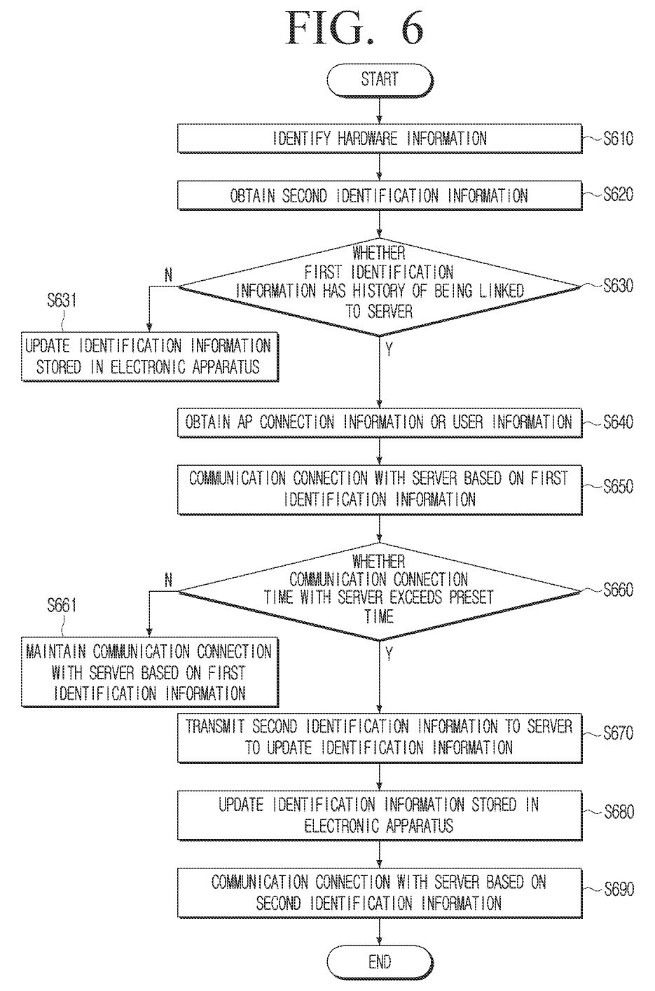

FIG. 6 is a flowchart provided to explain an operation of managing identification information by an electronic apparatus according to an embodiment of the disclosure.

The at least one processor 130 may identify that hardware information of the electronic apparatus 100 has been changed through the unique information detection module 131 at operation S610.

The at least one processor 130 may obtain second identification information of the electronic apparatus 100 based on the changed hardware information at operation S620.

The at least one processor 130 may identify whether the first identification information has a history of being linked to the server 200 at operation S630.

When it is identified that the first identification information has a history of being linked to the server 200, the at least one processor 130 may obtain connection information or user information for the AP 400 at operation S640.

When it is identified that the first identification information has a history of being linked to the server 200, the at least one processor 130 may perform a communication connection with the server 200 based on the linked first identification information at operation S650.

In this case, the at least one processor 130 may perform a communication connection with the AP 400 based on the connection information or the user information for the AP 400, and may perform a communication connection with the server 200 through the AP 400. However, the disclosure is not limited thereto, and the at least one processor 130 may be directly connected to the server 200 to perform communication without going through the AP 400.

When the communication connection with the server 200 is established based on the linked first identification information, the at least one processor 130 may identify whether the time for which the communication connection with the server 200 is maintained exceeds a preset time at operation S660.

When it is identified that the time for which the communication connection with the server 200 is maintained exceeds a preset time, the at least one processor 130 may transmit the second identification information to the server 200 so that the linked first identification information is updated to the second identification information at operation S670.

When it is identified that the time for which the communication connection is maintained does not exceed a preset time, the at least one processor 130 may maintain a communication connection with the server 200 based on the linked first identification information at operation S661.

For example, when the preset time is 1 hour and the time for which the communication connection with the server 200 is maintained is less than 1 hour, communication with the server 200 is performed using the existing first identification information, and when the time for which the communication connection with the server 200 is maintained exceeds 1 hour, the first identification information may be updated to the second identification information and communication with the server 200 may be performed using the updated second identification information.

When it is identified that the first identification information having a history of being linked to the server 200, the at least one processor 130 may transmit the second identification information to the server 200 so that the linked first identification information is updated to the second identification information at operation S670.

When the first identification information linked to the server 200 is updated to the second identification information, the at least one processor 130 may update the first identification information stored in the memory 120 to the second identification information at operation S680.

The at least one processor 130 may perform a communication connection with the server 200 based on the second identification information at operation S690.

Meanwhile, when it is identified that the first identification information has no history of being linked to the server 200, the at least one processor 130 may update the first identification information stored in the memory 120 to the second identification information without performing a communication connection with the server 200 based on the first identification information at operation S631.

FIG. 7 is a flowchart provided to explain an operation of updating identification information by a server according to an embodiment of the disclosure.

When the electronic apparatus 100 transmits the second identification information to the server 200 so that the linked first identification information is updated to the second identification information, the server 200 may receive the second identification information from the electronic apparatus 100 at operation S710, and may identify whether the identification information of the external device registered in the server 200 and the second identification information match at operation S720.

When the identification information of the external device registered in the server 200 and the second identification information do not match, the server 200 may transmit permission information for the second identification information to the electronic apparatus 100 and update the identification information at operation S730.

Here, the permission information for the second identification information may mean information that allows updating the first identification information to the second identification information when the identification information of the external device registered in the server 200 does not match the second identification information.

When the identification information of the external device registered in the server 200 and the second identification information match, the server 200 may transmit non-permission information for the second identification information to the electronic apparatus 100 at operation S740.

Here, the non-permission information for the second identification information may mean information for preventing duplicate registration of the external device and the electronic apparatus 100 for the same identification information when the identification information of the external device registered in the server 200 and the second identification information match.

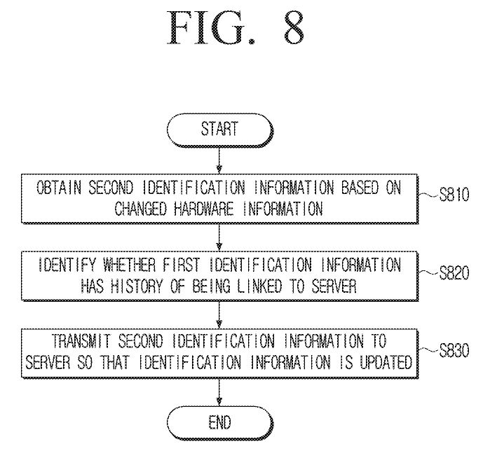

FIG. 8 is a flowchart provided to explain a method of managing identification information by an electronic apparatus according to an embodiment of the disclosure.

Referring to FIG. 8, when hardware information of the electronic apparatus is changed, the electronic apparatus may obtain the second identification information of the electronic apparatus based on the changed hardware information at operation S810. Here, the hardware information of the electronic apparatus may be unique information of the hardware that constitutes the electronic apparatus.

The electronic apparatus may identify whether the first identification information of the electronic apparatus has a history of being linked to a server at operation S820.

When it is identified that the electronic apparatus identifies that the first identification information has a history of being linked to the server, the electronic apparatus may transmit the second identification information to the server so that the linked first identification information is updated to the second identification information at operation S830.

Here, the identification information of the electronic apparatus may be information for uniquely identifying the electronic apparatus. Specifically, the identification information may include hardware information. Such identification information may change according to changes in the hardware information of the electronic apparatus, and may also be expressed as a device ID.

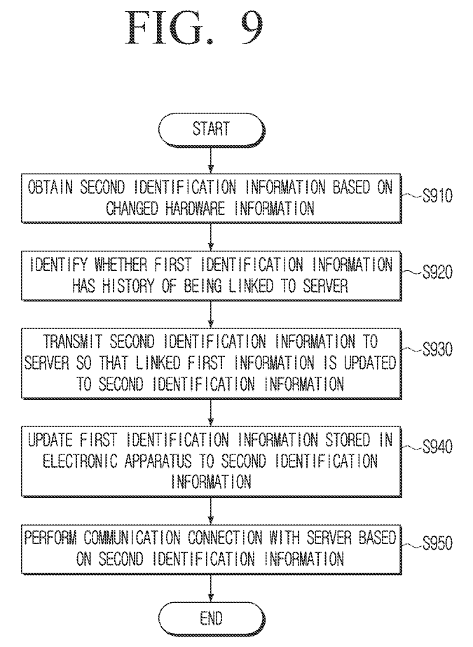

FIG. 9 is a flowchart provided to explain a method of managing identification information by an electronic apparatus according to an embodiment of the disclosure.

Referring to FIG. 9, when hardware information of the electronic apparatus is changed, the electronic apparatus may obtain the second identification information of the electronic apparatus based on the changed hardware information at operation S910.

The electronic apparatus may identify whether the first identification information of the electronic apparatus has a history of being linked to a server at operation S920.

When it is identified that the first identification information has a history of being linked to the server, the electronic apparatus may perform a communication connection with the server based on the linked first identification information.

When it is identified that the first identification information has a history of being linked to a server, the electronic apparatus may perform a communication connection with the server and transmit the second identification information to the server so that the first identification information linked to the server is updated to the second identification information at operation S930.

When the first identification information linked to the server is updated to the second identification information, the electronic apparatus may update the first identification information stored in the electronic apparatus to the second identification information at operation S940.

When the first identification information stored in the electronic apparatus is updated to the second identification information, the electronic apparatus may perform a communication connection with the server based on the second identification information at operation S950.

The method of managing the identification information of the electronic apparatus described in FIGS. 8 and 9 may be performed by devices having various configurations such as FIGS. 2 and 3 described above, but is not necessarily limited thereto, and may also be performed by devices having various configurations.

The various embodiments described above may be implemented as a single embodiment, or at least one of the embodiments may be combined with each other as a whole or in part and implemented together in one device.

FIG. 10 is a sequence view illustrating an order in which the electronic apparatus 100 and the server 200 operate according to an embodiment of the disclosure.

Although FIG. 10 illustrates that the electronic apparatus 100 and the server 200 perform communication directly, the disclosure is not limited thereto, and the AP 400 may relay communication between the electronic apparatus 100 and the server 200 as illustrated in FIG. 11 below.

Referring to FIG. 10, when hardware information of the electronic apparatus 100 is changed, the electronic apparatus 100 obtains the second identification information of the electronic apparatus 100 based on the changed hardware information at operation S1010.

The electronic apparatus 100 identifies whether the first identification information has a history of being linked to the server 200 at operation S1020. The electronic apparatus 100 transmits the second identification information to the server 200.

The server 200 identifies whether the received second identification information matches the identification information of the external device registered in the server 200 at operation S1030.

When the identification information of the external device registered in the server 200 does not match the second identification information, the server 200 updates the first identification information stored in the server 200 to the second identification information at operation S1040.

The server 200 transmits permission information for the second identification information. Here, the permission information for the second identification information may be information that allows updating the first identification information to the second identification information when the identification information of the external device registered in the server 200 does not match the second identification information.

When receiving the permission information for the second identification information from the server 200, the electronic apparatus 100 updates the first identification information stored in the electronic apparatus 100 to the second identification information at operation S1050.

FIG. 11 is a sequence view illustrating an order in which an electronic apparatus, an access point (AP) and a sever operate according to an embodiment of the disclosure.

Referring to FIG. 11, when hardware information of the electronic apparatus 100 is changed, the electronic apparatus 100 obtains the second identification information of the electronic apparatus 100 based on the changed hardware information at operation S1110.

The electronic apparatus 100 identifies whether the first identification information has a history of being linked to the server 200 at operation S1120.

When it is identified that the first identification information has a history of being linked to the server 200, the electronic apparatus 100 obtains connection information or user information for the AP 400.

The electronic apparatus 100 performs a communication connection with the AP 400 based on the obtained connection information or user information for the AP 400.

The electronic apparatus 100 establishes a communication connection with the server 200 through the AP 400 and transmits the second identification information to the server 200.

The server 200 identifies whether the received second identification information matches the identification information of the external device registered in the server 200 at operation S1130.

When the identification information of the external device registered in the server 200 does not match the second identification information, the server 200 updates the first identification information stored in the server 200 to the second identification information at operation S1140.

The server 200 transmits permission information for the second identification information. Here, the permission information for the second identification information may be information that allows updating the first identification information to the second identification information when the identification information of the external device registered in the server 200 does not match the second identification information.

When receiving the permission information for the second identification information from the server 200, the electronic apparatus 100 updates the first identification information stored in the electronic apparatus 100 to the second identification information at operation S1150.

According to the various embodiments described above, even if the hardware information of the electronic apparatus is replaced and the identification information of the electronic apparatus is changed, the changed identification information can be linked to the server without the user’s intervention, thereby providing convenience to the user. Ultimately, the user’s experience can be improved.

The various embodiments of the disclosure may be implemented as software stored in a machine-readable storage medium that can be installed or connected to a smartphone, a user terminal device, or other various electronic apparatuses (e.g., a computer).

Specifically, a non-transitory computer-readable storage media may be provided having software stored thereon for sequentially performing the steps of: when hardware information of the electronic apparatus is changed, obtaining second identification information of the electronic apparatus based on the changed hardware information; identifying whether first identification information of the electronic apparatus has a history of being linked to a server; and when it is identified that the first identification information has a history of being linked to the server, transmitting the second identification information to the server so that the linked first identification information is updated to the second identification information.

An apparatus equipped with such a non-transitory readable media can perform various operations, such as the operations of identifying a tag, checking the importance of each of a plurality of frames, generating edited images, etc. corresponding to the user operations described in the above-identified various embodiments.

In the non-transitory computer-readable media, the term ‘non-transitory’ means that the storage medium is tangible without including a signal, and does not distinguish whether data are semi-permanently or temporarily stored in the storage medium.

Alternatively, a program for performing a method according to the above-described various embodiments may be distributed online through an application store. In case of the online distribution, at least a portion of a computer program product may be at least temporarily stored in a storage medium such as memory of a server of a manufacturer, a server of an application store, or a relay server or be temporarily generated.

The components (for example, modules or programs) according to various embodiments may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration.

Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is Claimed is:

1. An electronic apparatus comprising:
a communication interface for performing communication with a server;
memory, comprising one or more storage media, storing instructions and first identification information of the electronic apparatus, which is generated based on hardware information of the electronic apparatus; and
at least one processor communicatively coupled to the communication interface and the memory and capable of executing the instructions,
wherein the instructions, when executed by the at least one processor individually or collectively, cause the electronic apparatus to:
based on the hardware information being changed, obtain second identification information of the electronic apparatus,
identify a log that the first identification information has been transmitted to the server, and
based on identifying the log, transmit the second identification information to the server to update identification information of the electronic apparatus in the server to the second identification information.

2. The apparatus of claim 1, wherein the instructions that, when executed by the at least one processor individually or collectively, cause the electronic apparatus to, based on identifying the log, perform a communication with the server based on the first identification information.

3. The apparatus of claim 1, wherein the instructions that, when executed by the at least one processor individually or collectively, cause the electronic apparatus to:
based on the identification information of the electronic apparatus in the server being updated to the second identification information, update the first identification information stored in the memory to the second identification information, and
perform a communication with the server based on the second identification information.

4. The apparatus of claim 1, wherein the instructions that, when executed by the at least one processor individually or collectively, cause the electronic apparatus to:
based on identifying the log, obtain information to connect to an Access Point (AP) or user information, and
perform a communication with the AP based on the information to connect to the AP or the user information, and perform a communication with the server through the AP.

5. The apparatus of claim 1, wherein the instructions that, when executed by the at least one processor individually or collectively, cause the electronic apparatus to, based on not identifying the log, update the first identification information stored in the memory to the second identification information.

6. The apparatus of claim 1, wherein the instructions that, when executed by the at least one processor individually or collectively, cause the electronic apparatus to:
based on identifying the log, perform a communication with the server based on the transmitted first identification information, and
based on a time for which the communication with the server is maintained exceeding a preset time, transmit the second identification information to the server to update the identification information of the electronic apparatus in the server to the second identification information.

7. The apparatus of claim 6, wherein the instructions that, when executed by the at least one processor individually or collectively, cause the electronic apparatus to:
based on a time for which the communication with the server is maintained not exceeding a preset time, maintain the communication with the server based on the transmitted first identification information.

8. The apparatus of claim 1, wherein the instructions that, when executed by the at least one processor individually or collectively, cause the electronic apparatus to:
transmit the second identification information to the server to update the identification information of the electronic apparatus in the server to the second identification information, and based on permission information for the second identification information being received from the server based on the second identification information, update the first identification information stored in the memory to the second identification information, and
perform a communication with the server based on the second identification information.

9. The apparatus of claim 8, wherein the permission information for the second identification information is information that permits updating the identification information to the second identification information based on identification information of an external device registered in the server not matching the second identification information.

10. A method of controlling an electronic apparatus that manages identification information of the electronic apparatus, the method comprising:
based on hardware information of the electronic apparatus being changed, obtaining second identification information of the electronic apparatus;
identifying a log that first identification information of the electronic apparatus has been transmitted to a server; and
based on identifying the log, transmitting the second identification information to the server to update identification information of the electronic apparatus in the server to the second identification information.

11. The method of claim 10, wherein the transmitting of the second identification information to the server comprises, based on identifying the log, performing a communication with the server based on the first identification information.

12. The method of claim 10, further comprising:
based on the identification information of the electronic apparatus in the server being updated to the second identification information, updating the first identification information stored in the electronic apparatus to the second identification information; and
performing a communication with the server based on the second identification information.

13. The method as claimed in of claim 10, further comprising:
based on identifying the log, obtaining information to connect to an Access Point (AP) or user information; and
performing a communication with the AP based on the information to connect to the AP or the user information, and performing a communication with the server through the AP.

14. The method of claim 10, further comprising:
based on not identifying the log, updating the first identification information stored in the electronic apparatus to the second identification information.

15. The method of claim 10, further comprising:
based on identifying the log, performing a communication with the server based on the transmitted first identification information; and
based on a time for which the communication with the server is maintained exceeding a preset time, transmitting the second identification information to the server to update the identification information of the electronic apparatus in the server to the second identification information.

16. The method of claim 15, further comprising:
based on a time for which the communication with the server is maintained not exceeding a preset time, maintaining the communication with the server based on the transmitted first identification information.

17. The method of claim 10, further comprising:
transmitting the second identification information to the server to update the identification information of the electronic apparatus in the servers that the linked first identification information is updated to the second identification information, and based on permission information for the second identification information being received from the server based on the second identification information, updating the first identification information stored in memory to the second identification information; and
performing a communication with the server based on the second identification information.

18. The method of claim 17, wherein the permission information for the second identification information is information that permits updating the identification information to the second identification information based on identification information of an external device registered in the server not matching the second identification information.

19. The method of claim 10, wherein the hardware information of the electronic apparatus is unique information of the hardware that constitutes the electronic apparatus.

20. One or more non-transitory computer-readable storage media storing one or more computer programs including computer-executable instructions that, when executed by one or more processors of an electronic apparatus individually or collectively, causes the electronic apparatus to perform operations, the operations comprising:
based on hardware information of the electronic apparatus being changed, obtaining second identification information of the electronic apparatus;
identifying a log that first identification information of the electronic apparatus has been transmitted to a server; and
based on identifying the log, transmitting the second identification information to the server to update identification information of the electronic apparatus in the server to the second identification information.
